(19) United States
(12) Patent Application Publication
(10) Pub. No.: US 2025/0149839 A1
(43) Pub. Date: May 8, 2025

(54) ELECTRICAL CONNECTOR ASSEMBLY AND ASSOCIATED METHODS

(71) Applicant: Convergence Medical Sciences Ltd, Calgary (CA)

(72) Inventor: Steven Daniel ROY, Calgary (CA)

(21) Appl. No.: 18/727,818

(22) PCT Filed: Jan. 11, 2023
(86) PCT No.: PCT/CA2023/050023

§ 371 Date: Jul. 10, 2024

Related U.S. Application Data
(60) Provisional application No. 63/298,710, filed on Jan. 12, 2022.

(51) Int. Cl. H01R 29/00; H01R 13/621; H01R 24/86

(52) U.S. Cl. CPC H01R 29/00; H01R 13/621; H01R 24/86

(57) ABSTRACT

A connector assembly includes first and second connectors. Each connector has a plurality of terminals spatially distributed around an axis of a circularly symmetric surface. The second connector further includes diodes to control the direction of current flow between the terminals and an outflow point and an inflow point. The number of first terminals does not equal the number of second terminals such that, when the first and second surfaces are connected, regardless of the rotational orientation of the first surface with respect to the second surface, each pair of first terminals are electrically connected to the inflow and outflow points; and no pair of first terminals are electrically connected to the same second terminal.

### TECHNICAL FIELD

The present disclosure relates to wired connectors. In particular, this present disclosure relates to wired connectors which are free to rotate with respect to each other.

### BACKGROUND

Wired connectors typically come in two types:
Connectors which must be put together in a particular orientation (e.g., a USB connector); and
Connectors which can be put together in any orientation (e.g., conventional microphone or speaker jacks).

For the second type, the connectors are themselves are typically circularly symmetric, and the various terminals (e.g., right audio, left audio, ground) are arranged along the axis of the connectors.

U.S. Pat. No. 2,654,869 relates to an electric swivel plug. When the cord is rotated it will carry the center piece with it, the center piece being free to rotate upon the ball bearing members, the spring wiper fingers frictionally engaging the members and in the stationary outer housing so that a good electrical connection is completed between the cord and the prong members.

U.S. Pat. No. 3,193,636 relates to a rotatable multiple-lead electrical connector (title). An external ring gear could be affixed to the periphery of the base of the plug and a pinion connected to drive the base through the gear from a motor. If the receptacle were held stationary in a supporting structure, timed switching could be effected between the leads extending from each end of the connector by the rotation of the plug and the receptacle relative to one another at predetermined cyclic rates in opposite or the same direction determined by the motor to effect at least one cycle of timed switching. Alternatively, the plug might be held stationary while the receptacle is rotated at some constant predetermined velocity to effect at least one continuous cycle of timed switching.

U.S. Pat. No. 3,930,705 is directed to an electrical connector assembly including a cam surface on one connector body having recessed contacts and a cam follower on the other connector body having recessed contacts for guiding the connector bodies and contacts into proper engagement. Guide means are also provided on the connector bodies for facilely guiding the insertion of a socket contact into one of the bodies and a boot having improved guiding means is used for sealing and gripping the conductors connected to the contacts.

U.S. Pat. No. 6,623,500 discloses a switch mechanism within the switch end cap is electrically connected to the handpiece body in such a manner that permits the switch end cap to be freely rotated about the handpiece body, while still maintaining the electrical connection therebetween. This is accomplished by having conductive finger members and complementary conductive members provide the electrical connection between the switch end cap and the handpiece body. This permits a user to position the switch end cap in a desired location relative to the handpiece body and the instrument.

U.S. Pat. No. 7,125,257 relates to a power supply device includes a base and a plug. The base includes a top wall, and a recessed portion defined in the top wall. The plug is accommodated in the recessed portion, and is rotatable to different angles relative to the base according to corresponding requirements.

U.S. Pat. No. 9,450,323 relates to a terminal fitting connection structure and rotary fitting-type connector. A second terminal fitting which abuts and is connected to a first terminal fitting includes a second annular portion formed at the tip end of a second terminal body which extends on a center axis thereof, a plurality of contact surfaces which protrude from the outer periphery of the second annular portion at the same intervals as those of a plurality of contact protrusions in the first terminal fitting, and a plurality of contact release portions which are positioned between the adjacent contact surfaces.

U.S. Pat. No. 10,016,556 relates to a rotatable electrical connector including a base housing having a bottom surface, a top housing that is rotatably engaged with the base housing, and a plurality of contact pads that are arranged radially within the base housing. The contact pads each have a top surface and a bottom surface. A plurality of signal pins is individually associated with the plurality of contact pads; and each of the signal pins correspondingly project outwardly from the bottom surface of an associated contact pad and outwardly from the bottom surface of the base housing (abstract).

U.S. Pat. No. 10,714,861 relates to an apparatus that includes a male-connector body comprising at least one mating surface, and shaped to define a hollow core. A plurality of electrically conductive male-connector terminals is coupled to the mating surface of the male-connector body. A longitudinal insert is configured to, by moving inside the hollow core, push the male-connector terminals radially outward (abstract).

WO 2019/119033 relates to an electrical mounting rail portion has an elongate body to which an electrical device is mountable at two or more different angular orientations about the elongate body.

### SUMMARY

In accordance with the present disclosure, there is provided a connector assembly comprising:
a first connector comprising a plurality of discrete first terminals spatially distributed around an axis of a circularly symmetric first surface, the discrete first terminals forming discrete first terminal pairs whereby a potential difference can be applied between each first terminal pair;
a second connector having a plurality of discrete second terminals spatially distributed around a circularly symmetric second surface, each of the discrete second terminals:
being connected to a common outflow point with an outflow diode configured to allow electric current to flow from the discrete second terminal to the outflow point, and
being connected to an inflow point with an inflow diode configured to allow electric current to flow from the inflow point to the discrete second terminal;
wherein the number of discrete first terminals does not equal the number of discrete second terminals such that, when the first and second surfaces are connected, regardless of the rotational orientation of the first surface with respect to the second surface:
at least one pair of discrete first terminals are electrically connected to the inflow and outflow points; and
no pair of discrete first terminals are electrically connected to the same discrete second terminal.

The connector assembly may comprise a fluid channel arranged axially through the first and second connectors.

The width of each of the second terminals may be less than the width of the gap between the first terminals.

The connector assembly may comprise a screw arranged axially (e.g. coaxially with the rotation axis) with respect to the first and second connectors, the screw being configured to physically hold the first and second connectors together.

The first and second surfaces may be complementary to allow the terminals to contact each other. Each terminal may be surrounded by electrically insulating material.

The first surface may be in the shape of a cone.

The first surface may be flat.

The first surface may be cylindrical.

One of the connectors may have one more terminal than the other connector.

One of the connectors may have two more discrete terminals than the other connector.

One of the connectors may have twice as many discrete terminals as the other connector.

Each discrete first terminal may successively connect with different discrete second terminals as the first and second connectors are rotated with respect to each other (e.g. about a rotation axis).

The assembly may be configured to detect when two discrete second connectors are connected to the same first terminal.

The assembly may be configured to detect the changes in orientation of the first and second connectors based on which two discrete second connectors are connected to the same first terminal; and to control a control parameter of a connected device based on the detected change in orientation.

The assembly may be configured to determine the relative rotation of the discrete terminals based on which discrete first terminals are in contact with which discrete second terminals.

The assembly may comprise a common first terminal and a common second terminal, wherein, when the first and second surfaces are connected regardless of the rotational orientation of the first surface with respect to the second surface, the common first and second terminals are electrically connected.

The first terminals may have the same shape and size, and second first terminals have the same shape and size.

The first terminals may be equally spaced around the rotation axis on the first surface, and second first terminals are equally spaced around the rotation axis on the second surface.

The first terminals may have n-fold rotational symmetry, wherein n is the number of first terminals.

The second terminals may have m-fold rotational symmetry, wherein m is the number of second terminals.

At least one of the first and second terminals may be a screen-printed electrode.

The connector assembly may comprise multiple sets of first and second terminals, arranged such that each set of first terminals can only connect with the corresponding set of second terminals.

Electronic components (e.g., a resistor) may be provided between the outflow and inflow points to allow a return current.

The discrete terminals may have the shape defined by the area swept by a straight line of fixed length lying in a flat plane comprising the rotation axis, as the straight line is rotated across the surface around the rotation axis by an angle. This increases the contact between the discrete first and second terminals as they are rotated with respect to each other.

On a cylindrical surface, the discrete terminals may have a rectangular or square shape applied to the curved surface of the cylinder.

On a flat surface, the discrete terminals may have a double arc shape. A double arc shape is bounded by a distal arc away from the rotation axis, a proximal arc closer to the rotation axis, and two radii portions at either side.

The connection assembly may comprise more discrete second terminals than discrete first terminals.

The pairs of terminals may comprise two neighbouring terminals.

The arc dimension of each of the second terminals may be less than the arc gap between neighbouring first terminals. For example, the gap between first terminals may be 90° about the rotation axis. The arc dimension of the corresponding second terminals may be less than 90° (e.g., 60°). This ensures that the neighbouring first terminals cannot be connected to the same second terminal. In this case, an arc dimension of a terminal or gap is the angle from the rotation axis of the connector assembly subtended by the terminal or gap.

Using circularly (or cylindrically) symmetric surfaces on the connectors means that the connectors can easily rotate over each other as the first connector is rotated with respect to the second connector.

In the context of this disclosure, a diode may be considered to be a two-terminal electronic component that conducts current primarily in one direction (asymmetric conductance). A diode has relatively low resistance in one direction, and relatively high resistance in the other.

A terminal is the point at which a conductor from a component, device or network comes to an end. A terminal may be an electrical contact. An electrical contact is an electrical circuit component found in electrical switches, relays, connectors and circuit breakers. Each contact is a piece of electrically conductive material, typically metal. When a pair of contacts touch (e.g., a first and second terminal), they can pass an electrical current.

In the context of this disclosure an orientation agnostic connector assembly is one where, for the same input signal, the output signal is the same regardless of the relative orientation of the connectors.

According to a further aspect of the present disclosure, there is provided a device comprising the connector assembly.

The device may comprise a controller comprising a process and memory configured to store computer program code. The controller may be configured to control the device. The controller may be configured to control the device based on the orientation of the connector assembly. The controller may be configured to provide input signals (e.g. power and/or data) to be transmitted through the connector assembly. The device may comprise a base unit and one or more peripheral devices which can be connected to the base unit via the connector assembly. The base unit may be configured to receive data signals from the peripheral device. The peripheral devices may include sensors.

According to a further aspect, there is provided a connector assembly comprising:
a first connector comprising a plurality of discrete first terminals spatially distributed around an axis of a circularly symmetric first surface, the discrete first terminals forming discrete first terminal pairs whereby a potential difference can be applied between each first terminal pair;
a second connector having a plurality of discrete second terminals spatially distributed around a circularly symmetric second surface, each of the discrete second terminals:
being connected to a common outflow point with outflow circuitry configured to control electric current to flow from the discrete second terminal to the outflow point, and
being connected to an inflow point with inflow circuitry configured to control electric current to flow from the inflow point to the discrete second terminal;
wherein the number of discrete first terminals does not equal the number of discrete second terminals such that, when the first and second surfaces are connected, regardless of the rotational orientation of the first surface with respect to the second surface:
at least one pair of discrete first terminals are electrically connected to the inflow and outflow points; and
no pair of discrete first terminals are electrically connected to the same discrete second terminal.

The inflow and outflow circuitry may comprise one or more diodes.

The inflow and outflow circuitry may comprise an intelligent control system configured to determine the signal on each second terminal and connect each second terminal with either the inflow point or outflow point based on the determined signal.

The inflow and outflow circuitry may circuitry are configured to automatically direct the current to either the inflow or outflow point based on the nature of the signal.

### BRIEF DESCRIPTION OF THE DRAWINGS

Various objects, features and advantages of the present disclosure will be apparent from the following description of particular embodiments of the present disclosure, as illustrated in the accompanying drawings. The drawings are not necessarily to scale, emphasis instead being placed upon illustrating the principles of various embodiments of the present disclosure. Similar reference numerals indicate similar components.

FIG. 1a-c are schematic views of a connector assembly in three different rotational configurations.

FIG. 2a is a perspective view of a connector assembly with cylindrical contact surfaces.

FIG. 2b is a perspective view of a connector assembly with flat contact surfaces.

FIGS. 3a-3d are front views of connector pairs where one of the connectors has four terminals.

FIGS. 4a-4d are front views of connector pairs where one of the connectors has six terminals.

FIG. 5 is a schematic view of a connector assembly with a common ground terminal.

FIG. 6 is a schematic view of a connector assembly with a common terminal for alternating current.

FIG. 7 is a front views of a connector pairs where two sets of first terminals and two corresponding sets of second terminals.

### DETAILED DESCRIPTION

The inventor has realized that it may be possible to have an orientation agnostic connector by arranging multiple terminals around the axis of the connector (i.e., with discrete rotational symmetry for each connector instead of circular symmetry). By having different numbers of terminals on each connector, data signals or power can still be transmitted regardless of the relative orientation of the connectors, as shown below.

One advantage of this system is that multidirectional currents can be supported. For example, in a conventional headphone jack, each ring supports one current (e.g., right ear signal only). Using the present system this ring can be split into separate axial terminals to support multidirectional currents (e.g., right and left ear signals, or an outgoing current and a return current).

Various aspects of the present disclosure will now be described with reference to the figures. For the purposes of illustration, components depicted in the figures are not necessarily drawn to scale. Instead, emphasis is placed on highlighting the various contributions of the components to the functionality of various aspects of the present disclosure. A number of possible alternative features are introduced during the course of this description. It is to be understood that, according to the knowledge and judgment of persons skilled in the art, such alternative features may be substituted in various combinations to arrive at different embodiments of the present disclosure.

### Single Circuit Embodiment

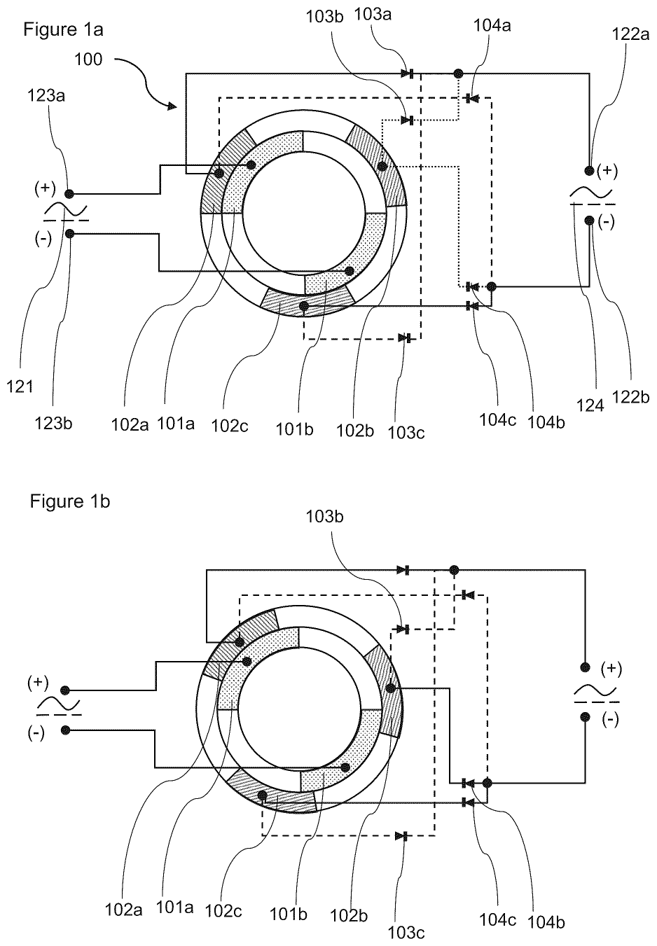

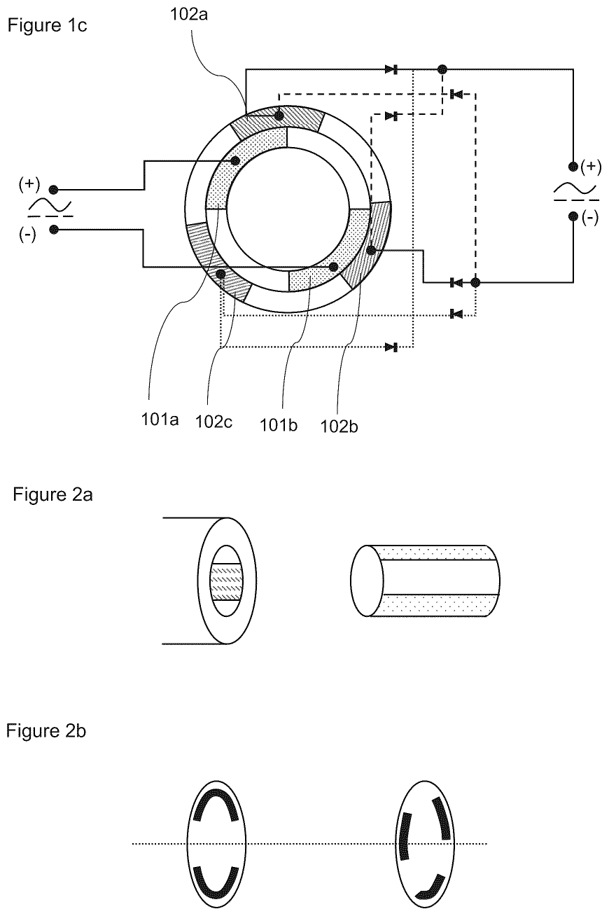

FIGS. 1a-1c shows an embodiment of a connector assembly 100 comprising:
a first connector comprising a plurality of discrete first terminals 101a,b spatially distributed around an axis of a circularly symmetric first surface, the discrete first terminals forming discrete first terminal pairs whereby a potential difference can be applied between each discrete first terminal pair;
a second connector having a plurality of discrete second terminals 102a,b,c spatially distributed around a circularly symmetric second surface, each of the discrete second terminals
being connected to a common outflow point 123 with an outflow diode 103a,b,c configured to allow electric current to flow from the discrete second terminal to the outflow point, and
being connected to an inflow point 124 with an inflow diode 104a,b,c configured to allow electric current to flow from the inflow point to the terminal;
wherein the number of discrete first terminals does not equal the number of discrete second terminals such that, when the first and second surfaces are connected regardless of the rotational orientation of the first surface with respect to the second surface:
each pair of discrete first terminals are electrically connected to the inflow and outflow points; and
no pair of discrete first terminals are electrically connected to the same discrete second terminal.

In this case, the first and second surfaces are cylindrical. That is, the first surface of the first connector is configured to be inserted inside the second surface of the second connector.

In this case, the first connector has two terminals (forming one pair), and the second connector has three terminals. For each connector, all the terminals have the same shape and size and are equally spaced around their respective surface. This means that the terminals of each connector has a respective n-fold discrete rotational symmetry. In this case, the first terminal has 2-fold rotational symmetry, and the second terminal has 3-fold rotational symmetry.

FIGS. 1a-1c show different rotational configurations of the two connectors. In order to show how the current flows, in these circuit diagrams:
Solid lines show wires in which current is flowing;
Dotted lines show wires in which no current is flowing because the second terminal is not connected to any first terminal; and
Dashed lines show wires in which no current is flowing because it is prevent from doing so by a diode.

In the situation depicted in FIG. 1a, the two first terminals are directly connected to an input signal 121 from input terminals 123a,b. The input signal may provide direct current for power or a data signal current. The connector assembly is configured to transport this signal to provide an output signal 124 across output terminals 122a,b, regardless of the orientation of the first and second connectors.

In FIG. 1a, second terminals 102a and 102c are connected to first terminals 101a and 101b respectively. Second terminal 103b is not connected to any first terminal. When a signal is applied to the input 121, the signal is applied across first terminals 101a and 101b and transferred to second terminals 102a and 102c through contact. The second terminals then transmit the signal on to the inflow and outflow points 122a and 122b.

In this embodiment, outflow point 122a is the positive side and inflow point 122b is the negative side of the output signal. Likewise, the input signal is provided by a positive side 123a and a negative side 123b.

Diodes between each of the second terminals 102a,b,c and the outflow point ensures that the outflow point can only receive current from the second terminals. Correspondingly diodes between each of the second terminals 102a,b,c and the inflow point ensures that the inflow point can never receive current from the second terminals.

For example, second terminal 102a is positive because it is connected to first terminal 101a which in turn is connected to positive input point 123a. The positive charge on 102a can be transmitted to outflow point 122a via diode 103a, but it cannot be transmitted to inflow point 122b because it is prevented from doing so by diode 104a.

Likewise, second terminal 102c is negative because it is connected to first terminal 101b which in turn is connected to negative input point 123a. The negative charge on 102c receive current from inflow point 122b via diode 104c, but it cannot receive current from outflow point 122b because it is prevented from doing so by diode 103c.

FIG. 1b shows the connectors in a different orientation. In this case, as before, second terminals 102a is connected to first terminal 101a. However, now second terminal 102b and 102c are both connected to first terminal 101b. The situation with first terminal 101a and second terminal 102a is similar to that shown in FIG. 1a.

In contrast, now that first terminal 101b is connected to both second terminals 102b and 102c, the return current going through first terminal 101b is shared between second terminals 102b and 102c. Again, diodes 104c and 104b facilitate this return current while diodes 103c and 103b prevent current passing from the outflow point from going directly to the second terminals 102b and 102c.

FIG. 1b shows the connectors in a further orientation. In this case, second terminal 102c has been further rotated so that it is no longer in contact with any first terminal (similar to second terminal 102b in FIG. 1a).

In this situation, first terminal 101a is connected to second terminal 102a and first terminal 101b is connected to second terminal 102b.

It will be appreciated that regardless of the orientation of the first and second connectors, each pair of first terminals 101a,b are electrically connected to the inflow and outflow points; and no pair of first terminals 101a,b are electrically connected to the same second terminal (which would cause a short circuit). Therefore, the connection assembly is configured to support an outgoing current and a return current regardless of the orientation of the connectors.

In this embodiment, the diode arrangement effectively acts as a rectifier. Therefore, this connector assembly can facilitate the transmission of signals which do not require the direct of the current to change.

### Surface Shapes

FIGS. 2a and 2b show two different possible shapes for the first and second surfaces.

FIG. 2a shows one embodiment with cylindrical surfaces. In this embodiment, one of the connectors can be inserted inside the other to effect connection. In this embodiment, the discrete terminals are arranged around an outer cylindrical surface of the inserted connector and around an inside cylindrical surface of the receiving connector.

FIG. 2b shows an embodiment with a flat surface. In this embodiment, the terminals are connected by pushing the two surfaces of the connectors together. It will be appreciated that the connectors may have guides to facilitate rotation of the connectors around the rotation axis. In this case, the terminals are arranged circumferentially around a circle centered on the rotation axis.

It will be appreciated that other configurations are available. For example, the connectors may be arranged in the form of a cone.

### Terminal Arrangements

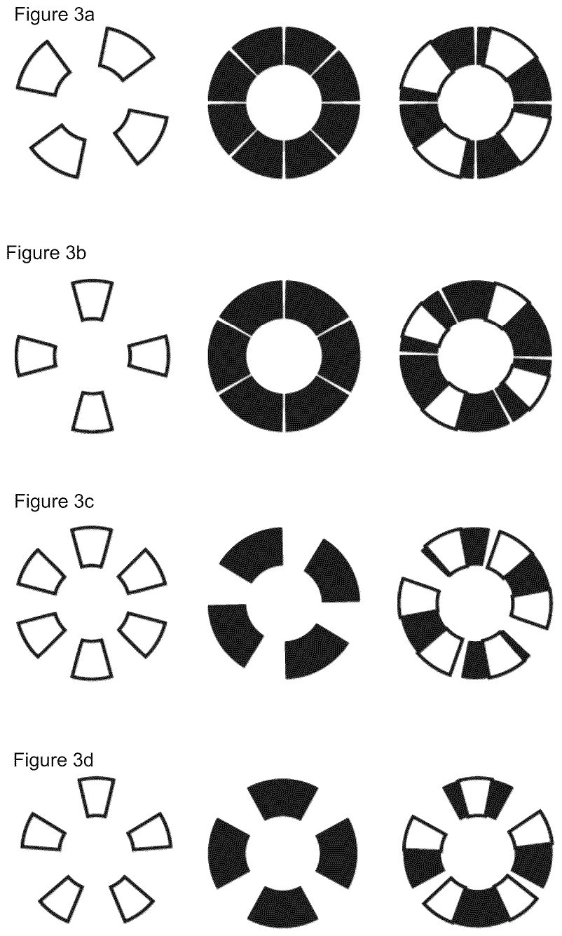

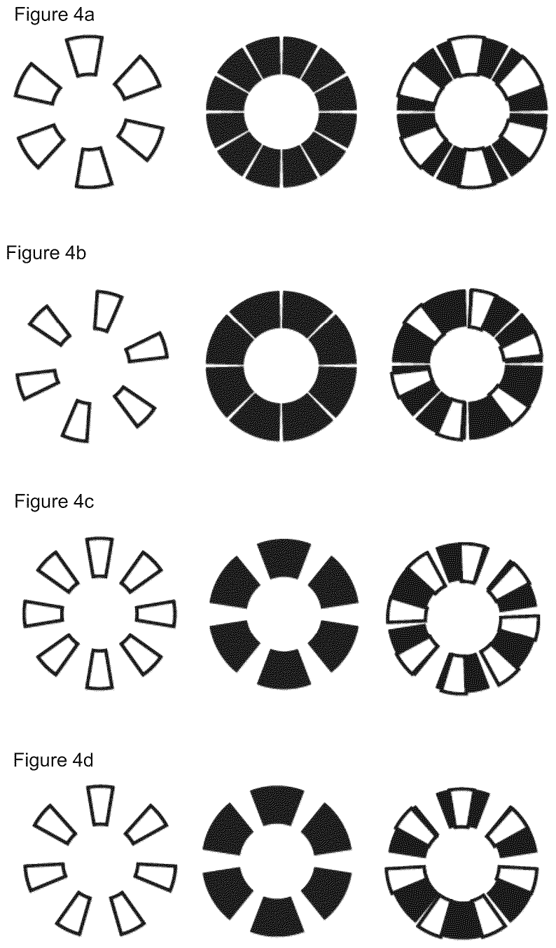

FIGS. 3a-d and 4a-4d show a number of possible arrangements for connectors with different numbers of terminals on each connector. FIGS. 3a-d have at least one connector with 4 terminals, and FIGS. 4a-4d have at least one connector with 6 terminals. In each figure, the left side in white is one terminal, the middle in black is the other terminals, and the right side shows how the two terminals interact with each other when in contact.

In general, it would be easier for the connector with the lower number of terminals to be the first connector to reduce the number of wires and diodes, although there are circumstances where the connector with the lower number of terminals to be the second connector. In many embodiments, the first connector will have an even number of terminals. In some embodiments, the first connector may have an uneven number of terminals because 1) there will always be a discrepancy on one of the connectors and 2) when there is a common ground, the pairs are with the common ground (i.e. pairs exist for all wires even if the number of wires is an odd number).

In some embodiments, one of the connectors comprises n terminals of width (in degrees) of 360°/2n (equally spaced, i.e. at 360°/2n). The other connector in this arrangement may have (2n) contacts of width (in degrees) 360°/2n (+small space, e.g. less than 5°, between each). Examples of this arrangement are shown in FIGS. 3a and 4a. That is, the width of each terminal is around 360/2n for both connectors, but in one connector there are n terminals with spacing n, and in the other connector there are 2n terminals with minimal spacing.

In other embodiments, one of the connectors comprises (n+1) contacts of width (in degrees) 360/(2n+4) (equally spaced). The other connector in this arrangement may have (n) contacts of width (in degrees) 360/(n+2)−small space at higher n (equally spaced). Examples of this arrangement are shown in FIGS. 3d and 4d. The system in FIG. 3d has a reasonably high contact area with a relatively small number of terminals.

In other embodiments, one of the connectors comprises (n) contacts of width (in degrees) 360/(2n+4) (equally spaced). The other connector in this arrangement may have (n+2) contacts of width (in degrees) 360/(n+2) (equally spaced, may need additional small space at higher n) Examples of this arrangement are shown in FIGS. 3b and 4b.

In other embodiments, one of the connectors comprises (n+2) contacts of width (in degrees) 360/(2n+4) (equally spaced). The other connector in this arrangement may have (n) contacts of width (in degrees) 360/(n+2) (equally spaced, may need additional small space at higher n). Examples of this arrangement are shown in FIGS. 3c and 4c.

Other configurations are also possible.

Regarding FIG. 3d, this embodiment has the property that regardless of the orientation of the connectors, only one of the 4-terminal connectors is connected to two of the 5-terminal connectors. Therefore, by monitoring which of the 4-terminal connectors is connected to two of the 5-terminal connectors, it is possible to determine the relative orientation of the connectors as they are rotated while in contact.

Which of the discrete first terminals are connected to which of the discrete second terminals can be monitoring the currents passing through each of the discrete first and second terminals. For example, if one first terminal is connected to two second terminals, the current passing through the first terminal will be split between the second terminals. Alternatively or in addition, the voltages between terminals can be used to determine which first terminal is connected to which second terminal.

Determining the relative rotation of the connectors can be used to control certain parameters of the device. For example, if the connector was used to control headphones, the relative orientation of the connector could be used to control the volume. Rotating clockwise may be used to increase the volume, and counter-clockwise may be used to decrease the volume. It will be appreciated that the connector may be configured to adjust the control parameter based on rotation from an arbitrary starting position.

### Common Ground Circuit Embodiment

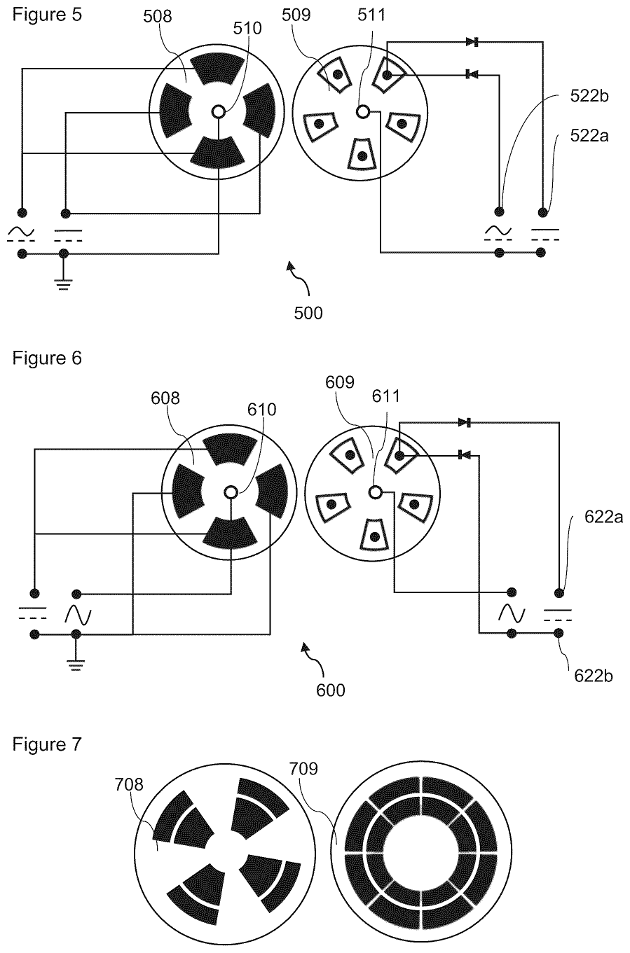

FIG. 5 shows a further embodiment 500 of a connector assembly comprising:
a first connector 508 comprising a plurality of discrete first terminals spatially distributed around an axis of a circularly symmetric first surface, the first terminals forming discrete first terminal pairs whereby a potential difference can be applied between each discrete first terminal pair;
a second connector 509 having a plurality of discrete second terminals spatially distributed around a circularly symmetric second surface, each of the second terminals
being connected to a common outflow point with an outflow diode configured to allow electric current to flow from the second terminal to the outflow point, and
being connected to an inflow point with an inflow diode configured to allow electric current to flow from the inflow point to the discrete second terminal;
wherein the number of discrete first terminals does not equal the number of discrete second terminals such that, when the first and second surfaces are connected regardless of the rotational orientation of the first surface with respect to the second surface:
each pair of discrete first terminals are electrically connected to the inflow and outflow points; and
no pair of discrete first terminals are electrically connected to the same second terminal.

In this case, the first and second surfaces are flat. For clarity, the connector surfaces are shown separated. In addition, only one of the second terminals are shown connected to the outflow 522b and inflow 522a points. It will be appreciated that each of the white second terminals are connected to both the outflow 522b and inflow 522a points with diodes to control the direction of current flow.

In this embodiment, the first terminals are arranged alternately around the first surface in pairs. That is, if one first terminal is connected to one input point, the neighbouring terminals of that terminal are connected to the other input point.

In this case, the connector assembly comprises a common first terminal 510 and common second terminal 511, wherein, when the first and second surfaces are connected regardless of the rotational orientation of the first surface with respect to the second surface, the common first and second terminals are electrically connected.

In this case, the common terminals are arranged centrally on the first and second surfaces. The common terminal in this case is connected to ground.

This means that, rather than simply carry the signal as in the embodiment of FIG. 1a, the pairs of terminals carry a direct current data signal, and direct current power.

Because the diodes act as a rectifier for signals transmitted through the non-common terminals, in this case, the voltage of the direct power voltage is always configured to be larger than the voltage of the direct current data signal.

### Alternating Current Embodiment

FIG. 6 shows a further embodiment 600 of a connector assembly comprising:
a first connector 608 comprising a plurality of discrete first terminals spatially distributed around an axis of a circularly symmetric first surface, the discrete first terminals forming discrete first terminal pairs whereby a potential difference can be applied between each discrete first terminal pair;
a second connector 609 having a plurality of discrete second terminals spatially distributed around a circularly symmetric second surface, each of the discrete second terminals
being connected to a common outflow point with an outflow diode configured to allow electric current to flow from the second terminal to the outflow point, and
being connected to an inflow point with an inflow diode configured to allow electric current to flow from the inflow point to the discrete second terminal;
wherein the number of discrete first terminals does not equal the number of discrete second terminals such that, when the first and second surfaces are connected regardless of the rotational orientation of the first surface with respect to the second surface:
each pair of first terminals are electrically connected to the inflow and outflow points; and
no pair of first terminals are electrically connected to the same second terminal.

In this case, the first and second surfaces are flat. For clarity, the connector surfaces are shown separated. In addition, only one of the discrete second terminals are shown connected to the outflow 622b and inflow 622a points. It will be appreciated that each of the white discrete second terminals are connected to both the outflow 622b and inflow 622a points with diodes to control the direction of current flow.

Like the embodiment of FIG. 5, the connector assembly also comprises a common first terminal and common second terminal, wherein, when the first and second terminals are connected regardless of the rotational orientation of the first surface with respect to the second surface, the common first and second terminals are electrically connected.

In this case, the common terminals are arranged centrally on the first and second surfaces. Unlike the previous embodiment, in this case, one first electrode in each first electrode pair is connected to ground. The common electrode is used to convey an alternating current data signal. Because the common electrode does not have a diode, it is possible to transmit alternating current on the common channel.

By providing direct current power between the first electrode pairs, where one terminal of each pair is ground, there is no issue with the diodes rectifying the current as it will always be travelling in the same direction.

This means that, rather than simply carry the signal as in the embodiment of FIG. 1a, the terminals carry an alternating current data signal, and direct current power.

### Multiple Arrays

In other embodiments, more channels can be supported by having multiple sets of first and second terminals. FIG. 7 shows first and second connectors 708, 709 with two sets of first terminals and two sets of second terminals.

It will be appreciated that the terminals should be arranged such that each set of first terminals can only connect with the corresponding set of second terminals. In the case of flat first and second surfaces, this can be achieved by arranging the terminal sets with different radial extents. In a cylindrical embodiment, the terminal sets may have different axial extents. In a conical embodiment, the terminal sets may be arranged at different distances along the conical surface.

### Other Options

The connector assembly may comprise a fluid channel arranged axially through the first and second connectors. For example, this system may be used where pipes or channels are connected together. This may include intravenous (IV) lines, transmitting data along connected pipes. The pipes may be industrial pipes, hydraulic pipes (e.g. connecting supply pipes from a tractor to a hydraulic ram on an agricultural implement, brake lines) or pneumatic lines. The connector assembly may be used for quick connectors for hydraulic/pneumatics, breakaway and other releasably engageable safety couplings, central vac inlets, trailer hitches and so on.

The connector assembly may comprise a screw arranged axially through the first and second connectors, the screw being configured to physically hold the first and second connectors together.

Although the present disclosure has been described and illustrated with respect to preferred embodiments and preferred uses thereof, it is not to be so limited since modifications and changes can be made therein which are within the full, intended scope of the present disclosure as understood by those skilled in the art.

What is claimed is:

1-24. (canceled)

25: A connector assembly comprising:
a first connector comprising a plurality of discrete first terminals spatially distributed around an axis of a circularly symmetric first surface, the discrete first terminals forming discrete first terminal pairs whereby a potential difference can be applied between each first terminal pair;
a second connector having a plurality of discrete second terminals spatially distributed around a circularly symmetric second surface, each of the discrete second terminals:
being connected to a common outflow point with an outflow diode configured to allow electric current to flow from the discrete second terminal to the outflow point, and
being connected to an inflow point with an inflow diode configured to allow electric current to flow from the inflow point to the discrete second terminal;
wherein a number of the discrete first terminals does not equal a number of the discrete second terminals such that, when the first and second surfaces are connected, regardless of a rotational orientation of the first surface with respect to the second surface:
at least one pair of discrete first terminals are electrically connected to the inflow and outflow points; and
no pair of discrete first terminals are electrically connected to a same one of the discrete second terminals.

26: The connector assembly according to claim 25, wherein the connector assembly comprises a fluid channel arranged axially through the first and second connectors.

27: The connector assembly according to claim 25, wherein the connector assembly comprises a screw arranged axially with respect to the first and second connectors, the screw being configured to physically hold the first and second connectors together.

28: The connector assembly according to claim 25, wherein the first surface flat, cone-shaped or cylindrical.

29: The connector assembly according to claim 25, wherein one of the connectors has one more terminal than the other connector.

30: The connector assembly according to claim 25, wherein one of the connectors has two more discrete terminals than the other connector.

31: The connector assembly according to claim 25, wherein one of the connectors has twice as many discrete terminals as the other connector.

32: The connector assembly according to claim 25, wherein the assembly is configured to detect when two discrete second connectors are connected to the same first terminal.

33: The connector assembly according to claim 32, wherein the assembly is configured to detect changes in orientation of the first and second connectors based on which two discrete second connectors are connected to the same first terminal; and to control a control parameter of a connected device based on the detected change in orientation.

34: The connector assembly according to claim 25, wherein the assembly is configured to determine a relative rotation of the discrete terminals based on which discrete first terminals are in contact with which discrete second terminals.

35: The connector assembly according to claim 25, wherein the connector assembly comprises a common first terminal and a common second terminal, wherein, when the first and second surfaces are connected regardless of the rotational orientation of the first surface with respect to the second surface, the common first and second terminals are electrically connected.

36: The connector assembly according to claim 25, wherein the first terminals have a same shape and size, and second first terminals have the same shape and size.

37: The connector assembly according to claim 25, wherein the first terminals are equally spaced around the rotation axis on the first surface, and second first terminals are equally spaced around the rotation axis on the second surface.

38: The connector assembly according to claim 25, wherein the first terminals have n-fold rotational symmetry, wherein n is the number of first terminals, and wherein the second terminals have m-fold rotational symmetry, wherein m is the number of second terminals.

39: The connector assembly according to claim 25, wherein at least one of the first and second terminals is a screen-printed electrode.

40: The connector assembly according to claim 25, wherein the connector assembly comprises multiple sets of first and second terminals, arranged such that each set of first terminals can only connect with a corresponding set of second terminals.

41: A connector assembly comprising:
a first connector comprising a plurality of discrete first terminals spatially distributed around an axis of a circularly symmetric first surface, the discrete first terminals forming discrete first terminal pairs whereby a potential difference can be applied between each first terminal pair;
a second connector having a plurality of discrete second terminals spatially distributed around a circularly symmetric second surface, each of the discrete second terminals:
being connected to a common outflow point with outflow circuitry configured to control electric current to flow from the discrete second terminal to the outflow point, and
being connected to an inflow point with inflow circuitry configured to control electric current to flow from the inflow point to the discrete second terminal;
wherein a number of the discrete first terminals does not equal a number of the discrete second terminals such that, when the first and second surfaces are connected, regardless of a rotational orientation of the first surface with respect to the second surface:
at least one pair of discrete first terminals are electrically connected to the inflow and outflow points; and
no pair of discrete first terminals are electrically connected to a same one of the discrete second terminals.

42: The connector assembly according to claim 41, wherein the inflow and outflow circuitry comprise one or more diodes.

43: The connector assembly according to claim 41, wherein the inflow and outflow circuitry comprise an intelligent control system configured to determine a signal on each second terminal and connect each second terminal with either the inflow point or outflow point based on the determined signal.

44: The connector assembly according to claim 43, wherein the inflow and outflow circuitry are configured to automatically direct the current to either the inflow or outflow point based on a nature of the determined signal.
